(19) United States
(12) Patent Application Publication
(10) Pub. No.: US 2023/0196604 A1
(43) Pub. Date: Jun. 22, 2023

(54) System and Method for Locating an Object in a Specified Area

(71) Applicant: RAYTHEON ANSCHÜTZ GMBH, Kiel (DE)

(72) Inventors: Michael WESSEL, Kiel (DE); Hinrich KAHL, Kiel (DE); Markus WERNER, Kiel (DE); Oliver WELZEL, Kiel (DE); Michael DELFS, Kiel (DE)

(21) Appl. No.: 18/015,179

(22) PCT Filed: Jul. 1, 2021
(86) PCT No.: PCT/DE2021/100567

§ 371 Date: Jan. 9, 2023

(30) Foreign Application Priority Data
Jul. 10, 2020 (DE) 10 2020 118 304.6

(51) Int. Cl. G06T 7/70; G06V 20/52; G06V 20/64; G06V 40/16; G06V 40/20; H04N 23/23

(52) U.S. Cl. CPC G06T 7/70; G06V 20/52; G06V 20/64; G06V 40/172; G06V 40/174; G06V 40/20; H04N 23/23; G06T 2207/10048; G06T 2207/30232; G06T 2207/30242

(57) ABSTRACT

The invention relates to a system for locating an object and optionally determining the dimension thereof in a specified area/space, comprising a plurality of cameras which capture the area from different locations, wherein a common detection region is provided for each of at least two cameras which are arranged at different locations; means for marking an object detected simultaneously by at least two cameras in the images captured by the respective cameras; and means for determining the position of the object marked in the images of the cameras by calculating the respective line of position between each camera and the object detected by each camera and by calculating the coordinates of the object at the intersection of the lines of position in a coordinate system mapping the area.

The invention relates to a system and a method for locating an object in a predetermined area.

The monitoring of areas, for example public spaces and public places, is largely carried out with video cameras and personnel evaluating the image material through visual control, who can also control the cameras, for example pivot them and thus change the coverage area of the camera. Alternatively, pivoting cameras can be controlled with people and/or object tracking algorithms and coupled with other surveillance equipment, such as short-range radars.

For the automatic monitoring of rooms and places, a spatial dimension can often also be determined from the 2-D image, so that individual sub-areas of the monitored area, such as entrances and exits to rooms and places, can be monitored separately. In addition, objects can be tracked, either in the 2-D plane of the image or the cameras pan behind the object by motor-driven camera mounting, and the position of the object is determined from a spatial depth calculation based on the 2-D image or by means of an additionally used laser range finder that can measure the distance between the camera and the object. This then results in the positions of the individual objects.

These methods require either a high level of personnel or equipment. On the one hand, different technologies (e.g., video camera, radar, laser measuring device) must be coupled with each other to enable reliable determination of the object's position and differentiation of the object type, e.g., vehicle, person, wheelchair user.

Therefore, there is a need for a simple, robust method to locate an object in a predetermined area that relies little to no on observation personnel, can reliably determine the current position of objects, and can provide it as process information.

The task of the present invention is therefore to provide a method and system corresponding to this need for localizing an object in a predetermined area, which can be implemented reliably, quickly and robustly, in each case with little effort, low complexity, preferably based on only one technology, easy to set up and calibrate.

According to the invention, this task is solved by the system having the features of claim 1 and the method having the features of claim 13. The dependent claims reflect advantageous embodiments of the invention.

The basic idea of the invention is to combine the optical direction finding and automatic determination of the position in a room/area of at least one object in one step in a monitoring system. For this purpose, at least three permanently installed cameras are preferably provided at positions offset at best by 90° from the central viewing axis of the cameras, at the outer edges/corners of the area to be monitored, whereby the cameras have a high angular accuracy, i.e. a true-angle resolution, particularly with a high angular resolution.

The at least two, preferably three (or more) cameras therefore have as little distortion as possible that contributes to angular distortion and are arranged in such a way that they can see the common area to be monitored without obstacles. The orientation of the optical axis of the camera in relation to a predetermined coordinate system with respect to the area to be monitored is assumed to be known so that it can be placed in the coordination system of the area to be monitored.

The objects located in the area to be monitored are preferably each automatically detected by the automatic image analysis of the at least two camera images, categorized (e.g. vehicle (aircraft, land vehicle, water vehicle, person, etc.) and the position and dimension (in all three dimensions) of the object in the image is determined.

By the determined position (and if necessary dimension) of the objects within a single image the position lines to the objects are determined, which in the combination of at least two, better three position lines of the at least two, better three cameras synchronized in time are then used for the automatic calculation of the position of the objects in the area.

Thus, the system and method according to the invention enable position determination/geo-localization of objects by means of automatic optical direction finding using at least two, preferably three (or more) cameras. Depending on requirements, daylight or infrared or thermal cameras can be used, individually or in combination. These are used in particular for monitoring rooms and/or surfaces in order to ensure the safety of persons or goods. This can be used to generate a situation image that represents the bird's eye view, known from the display of a radar image on a Plan Position Indicator (PPI), with the objects detected therein. It is important that the bearings of all cameras used are synchronized in time.

The system and the method are basically independent of the height topography of the area to be monitored, if only this representation is needed, since the result is a representation of the (geographical) position on the area. However, it is also possible to calculate the height of a flying object, e.g. a drone—in this case, the mounting height of the cameras must also be taken into account.

To calibrate the system, the optical axes of the cameras are (initially) aligned at least at the camera angle known to the perpendicular axis of the camera mount. These camera angles can also be referenced to a predetermined coordinate system used as a reference system that represents the coordinate system of the space/area to be monitored.

The determination of the position of the objects by means of the at least two, preferably three temporally synchronized stationary lines can be carried out by calculating a predetermined reference point of the room/area to be monitored. For this, only computational corrections of the camera positions in relation to the reference point have to be made, which can be carried out fully automatically.

Thus, according to the invention, a system for locating an object in a predetermined area is proposed, the system comprising

a plurality of cameras capturing different locations, wherein at least each two cameras located at different locations have a common capture area;
means for marking an object simultaneously captured by at least two cameras in the images respectively captured by the cameras; and
means for determining the position of the object marked in the images of the cameras by calculating the respective position line between the respective camera and the object detected by the respective camera and calculating the coordinates of the object at the point of intersection of the position lines in a coordinate system mapping the area.

Preferably, the system further comprises means arranged to issue an alarm when an object enters at least a portion of the area or exits at least a portion of the area.

In particular, the system is arranged to count predetermined objects detected by the cameras, and the system is particularly preferably arranged to output an alarm when a predetermined number of predetermined objects detected by the cameras is exceeded.

In particular, the system is set up to measure distances between the predetermined objects detected by the cameras, and the system is particularly preferably set up to issue an alarm when predetermined minimum distances or even maximum distances are exceeded.

The object detected by the system is preferably selected from the group of objects consisting of a human, an animal, a vehicle (air, land, and/or water vehicle), and/or an event.

The area monitored by the system is preferably selected from the areas consisting of a room, a surface, a square, the roof of a house, the deck of a ship, a railroad track, a platform, a bridge, an entrance or exit and a port.

According to another preferred embodiment, at least a subset of the cameras are arranged at the boundaries of the area.

At least a subset of the cameras is preferably designed as a thermal imaging camera or infrared in particular combined with an infrared source. With the help of this preferred embodiment, it is possible to facilitate the automated detection and marking of heat sources (e.g. also vehicles, drones, balloons) people and animals and also to map events, such as the occurrence of fires, tumults, etc., mark them accordingly and thus also localize them.

The means for marking an object simultaneously detected by at least two cameras in the images respectively recorded by the cameras are set up in particular for automatic object recognition and/or face recognition. Object recognition and/or face recognition also enables automated marking of the objects and people to be monitored in the predetermined area.

Specifically, the means for marking an object simultaneously captured by at least two cameras in the images respectively captured by the cameras are set up for automatic gesture and/or facial expression recognition. As a preferred embodiment, gesture and/or facial expression recognition additionally enables the detection of particular hazardous situations that may have a local origin and can be more easily identified and locally contained by applying the preferably designed method.

The coordinate system mapping the area is preferably a Cartesian coordinate system, whereby this can be designed particularly preferably as a three-dimensional coordinate system. If a three-dimensional coordinate system is used, the respective height and the respective angle of the optical axes of the cameras recording the area must be known at the same time and taken into account in the calculation of the booth lines.

Likewise, according to the invention, a method for locating an object in a predetermined area is proposed with the steps:

Detection of an object in an area captured by at least two cameras arranged at different locations,
Marking the object in the images captured by the cameras simultaneously,
Determining the position of the object in a coordinate system mapping the area by means of the marking made in the images of the cameras by calculating the respective standing line between the respective camera and the object detected by the respective camera and calculating the coordinates of the object at the intersection of the standing lines.

Additionally, the height of the object above the surface, derived from the known topography, or ground profile of the known area, can preferably be determined.

According to another preferred embodiment, the dimensions of the object in height, width, depth can also be determined.

In addition, it is preferably provided that an alarm is output when the object enters a predetermined subarea of the predetermined area or when the object leaves a predetermined subarea of the predetermined area. In particular, the frequency with which objects, especially people, enter or leave a predetermined area can be measured, so that, for example, an emergency situation can be detected or an emerging panic with a corresponding escape reaction can be detected and assistance measures can be taken.

The marking of the object is preferably done by means of a method for automatic object recognition.

The object detected by means of the method is preferably selected from the group of objects consisting of heat sources (e.g. also vehicles, drones, balloons), a human, an animal, a vehicle and/or an event.

The area monitored by the method is preferably selected from the areas consisting of a room, a square, the roof of a house, the deck of a ship, a railway track, a bridge, an entrance or exit and a harbor.

The system and method according to the invention can be used, for example, for monitoring boats and ships. For example, the German Navy is a guest at home and abroad in ports that do not belong to the German Navy. In such ports, the challenge is that a defined area in each case for which the Navy wishes to monitor a portion of the area around the mooring for the mooring time on site. In this case, the application of the present invention goes beyond pure video monitoring and extends it by adding the new function of displaying a situation image from a bird's eye view and displaying detected objects on this situation image. The situation picture comprises an area around the ship, for example up to approx. 150 m.

In particular, the exact location of watercraft can be determined, among other things, with the use of thermal cameras. In this case, the cameras are essentially trained to detect watercraft (ships, sailboats, people on SUPs).

Another application is to detect people in a room and, in particular, to count the number of people/objects in a freely definable area of the room in order to derive automated actions from this, for example to issue an alarm if too many people gather in this area. For example, even an accumulation of many people within a short period of time in an access to the room may indicate an event in the room that requires evacuation of the room.

By means of an installation of the system for monitoring house roofs, the position of persons in areas of a house roof can be located very precisely automatically in order to generate warnings/alarms therefrom when entry into a sub-area of the monitored area or exit from the area is reported at a certain area section suggesting suicidal intent.

In particular, the system is set up to measure distances between the predetermined objects detected by the cameras, and the system is particularly preferably set up to issue an alarm when predetermined minimum distances or even maximum distances are exceeded.

Similarly, man-over-board events can be captured on a ship, such as on the bow of the ship.

The localization according to the invention can also be used to precisely locate persons and/or vehicles in a track area or platform area, and can be linked to times when trains will pass the area where the persons/vehicles are located. From this, warnings/alarms can then in turn be issued to the rail operator, who can initiate suitable measures to prevent an accident in good time.

Likewise, the exact location of persons and/or vehicles on bridges/overpasses is possible. For example, if a person is sitting on a bridge railing or is already on the wrong side of the railing, a warning or alarm can be triggered.

With the localization according to the invention, the exact location of heat sources/fire sources can be carried out by using thermal cameras, for example on car decks of ferries, in warehouses, etc. Here, a sprinkler system can be controlled locally so that only the source of the fire is extinguished and the entire warehouse does not suffer water damage.

The detection in the cameras is trained in particular, among other things, on heat sources or on temperature changes and not exclusively on the detection of predefined objects such as cars or people. The change of temperatures and their shapes can then represent different object shapes. The criterion here is essentially the temperature change, which can be represented by the color or a color change.

In the following, the invention shall be described in more detail using a particularly preferably configured embodiment depicted in the attached drawings, in which:

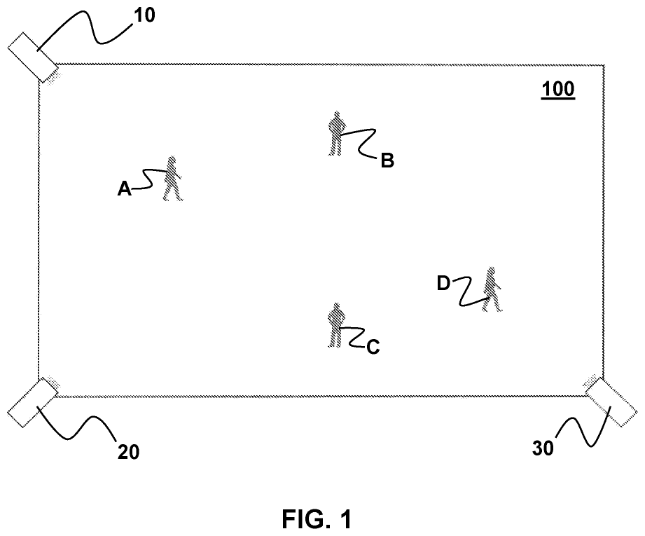

FIG. 1 shows a schematic plan view of an area monitored by a plurality of cameras in which four persons are located;

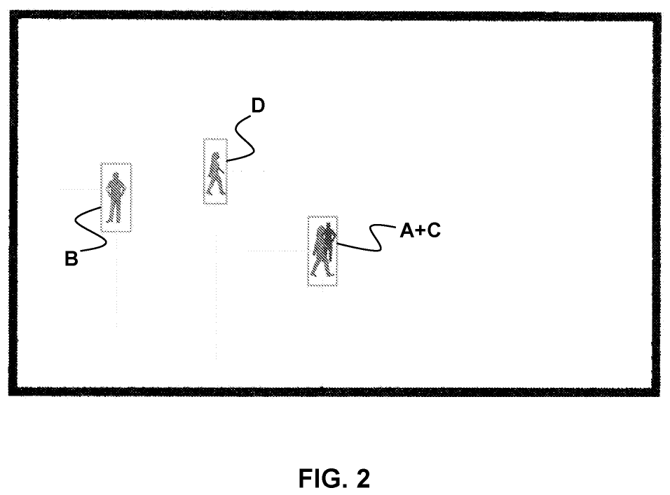

FIG. 2 shows a first image captured by a first camera;

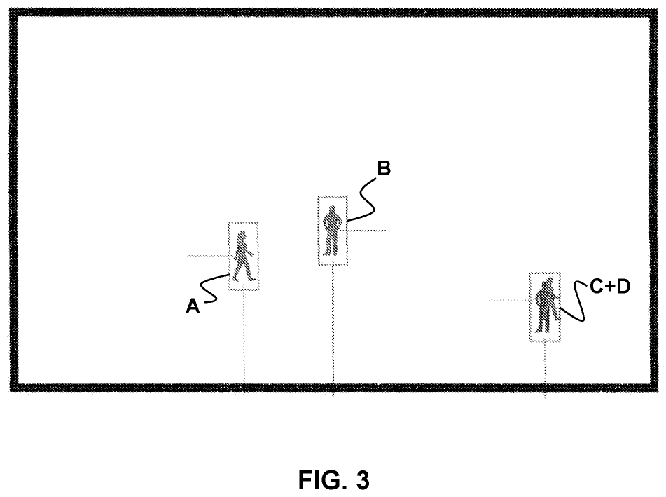

FIG. 3 shows a second image captured simultaneously by a second camera to the image captured by the first camera;

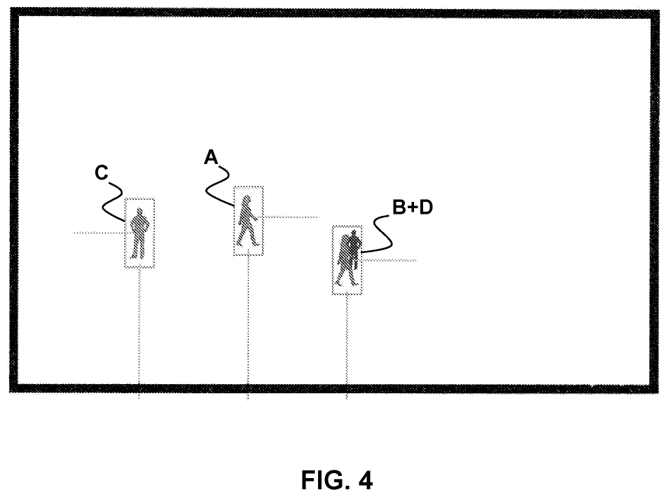

FIG. 4 shows a third image captured simultaneously by a third camera to the other images; and

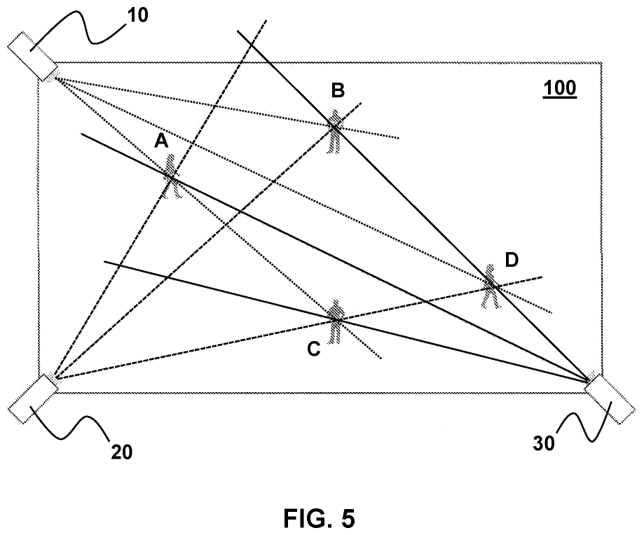

FIG. 5 shows a schematic plan view according to FIG. 1 with the stationary lines calculated for each camera and for each object.

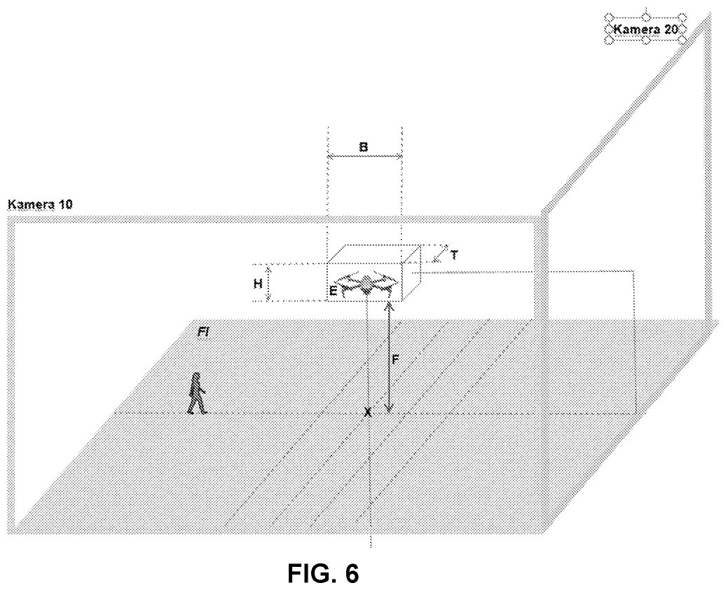

FIG. 6 shows a first image captured by the first camera together with the perspective image of the second camera of a space in which an airborne object is located at a height F with the dimensions H, W, D.

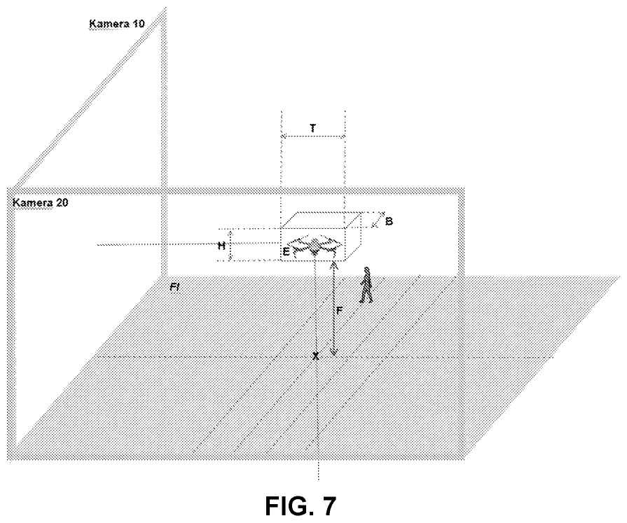

FIG. 7 shows an image captured at the same time by the second camera to the image of FIG. 6 of a space in which a flying object is located at the height F with the dimensions H, W, D

FIG. 1 shows a schematic plan view of an area monitored by a plurality of cameras in which four persons are located. In particular, FIG. 1 shows a particularly preferably designed system for locating persons A, B, C, D in a predetermined area 100 with a plurality of cameras 10, 20, 30 covering the area 100 from different locations.

The cameras 10, 20, 30 are located at the boundaries of the area 100, for example a room, a square or the deck of a ship, and are oriented such that each of the cameras 10, 20, 30 can basically detect any person A, B, C, D located in the area 100—the coverage area of the cameras 10, 20, 30 is thus essentially identical, although viewed from different locations. The cameras 10, 20, 30, which may be designed in particular as thermal imaging cameras, or the logic connected to them, have automatic object recognition so that marking of the persons in the images taken simultaneously by the cameras 10, 20, 30 takes place automatically.

The problem with locating all persons A, B., C, D in the area is that cameras 10, 20, 30 cannot capture all persons A, B, C, D equally well, because some of the persons A, B, C, D—depending on the angle of view of camera 10, 20, 30—are covered by another person A, B, C, D.

Thus, the respective images captured by the cameras 10, 20, 30 actually show only three persons each instead of the four persons A, B, C, D actually present in the area 100. Thus, the first image captured by the first camera 10 shown in FIG. 2 allows marking the persons B, D and A, but not the person C, which is obscured by the person A. In the second image taken by the second camera 20, shown in FIG. 3, person C obscures person D so that only persons A, B and C can be marked. Finally, in the third image of the third camera 30 shown in FIG. 4, person B is obscured by person D, so that only persons A, B and C can be marked.

Nevertheless, precise localization of all persons A, B, C, D in the monitored area 100 is possible by calculating—as shown in FIG. 5—the lines of sight between the persons A, B, C, D marked in the images of the cameras 10, 20, 30 and the respective cameras 10, 20, 30, the coordinates of the persons A, B, C, D resulting from the intersections of three lines of sight in each case in a coordinate system mapping the area.

1. System A system for locating an object in a predetermined area with:
a plurality of cameras covering the area from different locations, wherein at least two cameras arranged at different locations each have a common coverage area,
means for marking an object detected simultaneously by at least two cameras in the images respectively recorded by the cameras, and
means for determining the position of the object marked in the images of the cameras by calculating the respective position lines in the space between the respective camera and the object detected by the respective camera and calculating the coordinates of the object at the intersection of the position lines in a coordinate system mapping the area.

2. The system according to claim 1, further comprising means arranged to output an alarm upon entry of an object into at least a partial area of the area or exit of an object from at least a partial area of the area.

3. The system according to claim 1, wherein the system is arranged for counting predetermined objects detected by the cameras.

4. The system according to claim 3, wherein the system is arranged to output an alarm when a predetermined number of predetermined objects detected by the cameras is exceeded.

5. The system according to claim 1, wherein the object is selected from the group of objects consisting of a human, an animal, a vehicle and/or an event.

6. The system according to claim 1, wherein the area is selected from the areas consisting of a room, a surface, a square, a roof of a house, a deck of a ship, a track, a platform, a bridge, and a port.

7. The system according to claim 1, wherein at least a subset of the cameras is located at the boundaries of the area.

8. The system according to claim 1, wherein at least a subset of the cameras is configured as a thermal imaging camera.

9. The system according to claim 1, wherein the means for marking an object detected simultaneously by at least two cameras are set up for automatic object recognition and/or face recognition in the images respectively recorded by the cameras.

10. The system according to claim 1, wherein the means for marking an object detected simultaneously by at least two cameras in the images respectively recorded by the cameras are set up for automatic gesture and/or facial expression recognition.

11. The system according to claim 1, wherein the coordinate system is a Cartesian coordinate system.

12. The system according to claim 1, wherein the coordinate system is a three-dimensional coordinate system.

13. A method for locating an object in a predetermined area with the steps:
detecting an object in an area captured by at least two cameras arranged at different locations,
marking the object in the images captured simultaneously by the cameras, and
determining the position of the object in a coordinate system imaging the area by means of the marking made in the images of the cameras by calculating the respective standing line between the respective camera and the object detected by the respective camera and calculating the coordinates of the object at the intersection of the standing lines.

14. The method of claim 13, further comprising outputting an alarm when the object enters a predetermined portion of the predetermined area or exits a predetermined portion of the predetermined area.

15. The method according to claim 13, wherein the object is marked by means of a method for automatic object recognition.
